(19) United States
(12) Patent Application Publication
(10) Pub. No.: US 2021/0274972 A1
(43) Pub. Date: Sep. 9, 2021

(54) Frying Assembly for Flipping Food

(71) Applicant: Rennie West, Carson, CA (US)

(72) Inventor: Rennie West, Carson, CA (US)

(21) Appl. No.: 17/191,810

(22) Filed: Mar. 4, 2021

Related U.S. Application Data
(60) Provisional application No. 62/984,852, filed on Mar. 4, 2020.

(51) Int. Cl. A47J 37/10; A47J 37/04

(52) U.S. Cl. CPC A47J 37/108; A47J 37/049

(57) ABSTRACT

A frying assembly for flipping or rotating food in a pan is provided. The frying assembly safely allows a user to flip the racks of the frying assembly holding food from a first side to a second side, without having to individually rotate each piece of food. The frying assembly includes a pair of movable racks that are separated to form an interior space that is able to receive food. The racks are movable relative to each other, such that foods of various sizes may be sandwiched between the racks. Each rack includes apertures that allow fluid, such as oil, to contact the food and thereby cook it and an interior face having a plurality of tines protruding towards the interior space for securing the food. A handle extends from a bracket that is in turn secured to the racks.

### CROSS REFERENCE TO RELATED APPLICATION

This application claims the benefit of U.S. Provisional Application No. 62/984,852 filed on Mar. 4, 2020. The above identified patent application is herein incorporated by reference in their entirety.

### BACKGROUND OF THE INVENTION

The present invention relates to a frying assembly. The frying assembly provides a device that safely accommodates food for cooking of a first side and subsequently allows for flipping the food to a second side. The frying assembly comprises a first (top) rack and a second (bottom) rack, wherein each rack is operably connected at a first end to a bracket and in a stacked arrangement forming an interior space therebetween. The interior space is adapted to receive food such that the food remains between the racks on an interior face of each rack. The food is secured to the racks via tines configured to engage the food. Apertures in the racks allow oil in the pan to cook the food while in use. A handle extending from the racks allow a user to flip the racks to cook both the first and second side of the food without having the remove the food from the racks.

Typically, when cooking sliced vegetables or multiple fillets of meat or fish, the cook is required to periodically turn the food so that it can cook evenly on both sides. This act can be performed with a spatula or fork. However, both common methods of using a spatula or fork are problematic. First, use of a spatula requires positioning the spatula underneath the food and causing the food to be flipped within the pan. This flipping action creates a risk of splashing hot oil outside of the pan and onto cooking surfaces or the person cooking. Second, use of a fork to pierce the food does not provide sufficient distance between the oil and the hand of the cooker to safely operate. Moreover, when the fork is pierced into the food, the food may slip from the fork during the flipping operation causing the food to splash into the hot oil.

Some specialized cooking implements for manipulating and turning food during the cooking process exist. For example, some rotisserie assemblies include a motor that continuously rotates a rack over a heat source, such as a fire. However, these specialized cooking implements are not suitable for most cooking arrangements. Further, the flipping of these racks is not adapted for shallow frying in a pan. Therefore, there exists a need for a frying assembly that securely receives food between racks and allows a user to flip the assembly and secured food simultaneously without endangering the user with spatter from the oil.

In light of the systems and methods disclosed in the known art, it is submitted that the present invention substantially diverges in design elements and methods from the known art and consequently it is clear that there is a need in the art for a frying assembly. In this regard the instant invention substantially fulfills these needs.

### SUMMARY OF THE INVENTION

In view of the foregoing disadvantages inherent in the known types of flip frying assembly now present in the known art, the present invention provides a new flip frying assembly wherein the same can be utilized for shallow frying food and turning the assembly to cook both sides of the food.

It is an objective of the present invention to provide a flip frying assembly comprising a first rack and a second rack in a stacked arrangement forming an interior space therebetween. The interior space is adapted to receive food such that the food remains between the first and second rack on an interior face of each rack, wherein the interior faces are oriented towards the other rack, respectively.

It is another objective of the present invention to provide each rack with apertures that allow fluid, such as oil, to pass therethrough. The rack also includes a plurality of tines protruding towards the interior space, wherein each tine is adapted to pierce or otherwise engage food placed within the interior space.

It is yet another objective of the present invention to provide the first and second racks in a stacked arrangement such that the top and bottom racks are disposed on parallel, horizontal planes.

It is another objective of the present invention to provide first and second racks that are operably connected at a first end to a bracket, wherein the bracket is adapted to provide linear movement of the top rack relative to the bottom rack, such that the interior faces of the bottom rack and the top rack can be adjusted to sandwich food disposed between the racks.

It is yet another objective of the present invention to provide a handle affixed to the bracket, wherein the handle is adapted to rotate the racks so as to cooperatively rotate both the top and bottom racks about a longitudinal axis of the handle. In this way, the opposing sides of food positioned within the interior space are exposed to cooking oil in a pan. In one embodiment, the handle includes a hinge that provides for selective collapsing of the handle to a storage configuration.

It is yet another objective of the present invention to provide the top rack hingedly affixed to the bracket to allow for access to an interior face of the bottom bracket.

It is therefore an object of the present invention to provide a new and improved flip frying assembly that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows perspective view of an embodiment of the frying assembly for flipping.

FIG. 2 shows a side view of an embodiment of the frying assembly for flipping.

FIG. 3 shows a cross sectional view of a handle of an embodiment of the frying assembly for flipping.

FIG. 4 shows a perspective view of a second embodiment of the frying assembly for flipping.

FIG. 5 shows a perspective view of a third embodiment of the frying assembly for flipping.

FIG. 6 shows a perspective view of an embodiment of the frying assembly for flipping being used with a frying pan.

FIG. 7A shows a close-up, side view of an embodiment of the frying assembly with actuatable panel for detaching food from tines in a retracted position.

FIG. 7B shows a close-up, side view of an embodiment of the frying assembly with actuatable panel for detaching food from tines in a deployed position.

### DETAILED DESCRIPTION OF THE INVENTION

Reference is made herein to the attached drawings. For the purposes of presenting a brief and clear description of the present invention, the embodiment will be discussed as used for securing food within the racks and shallow frying food within a frying pan, and turning the frying assembly to cook both sides of the food. The figures are intended for representative purposes only and should not be considered to be limiting in any respect.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

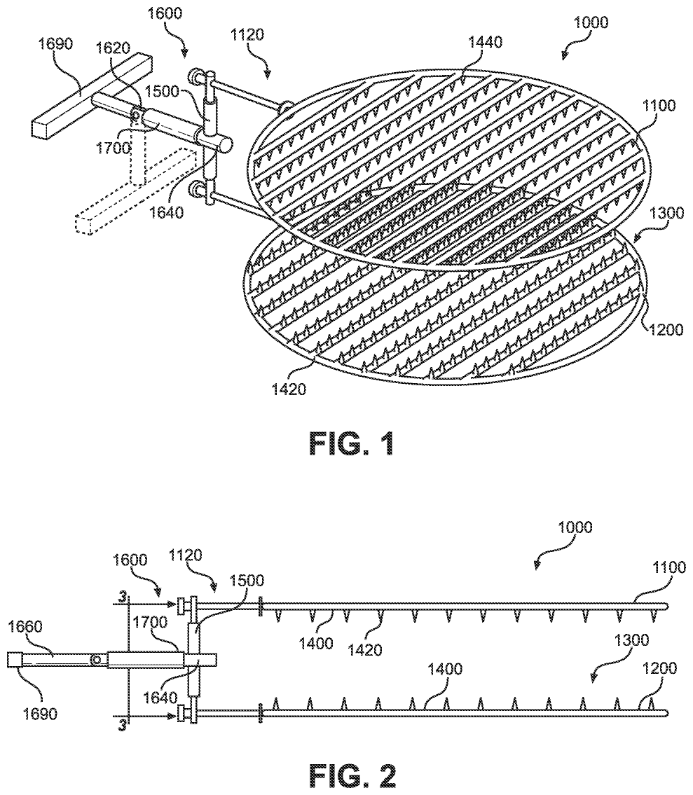

Referring now to FIGS. 1 and 2, there is shown a perspective view and a side view of an embodiment of the frying assembly for flipping, respectively. The present frying assembly 1000 provides a device for holding food within a pair of racks for cooking both sides of the food without having to remove the food from the assembly or individually rotate each piece of food. A rotating mechanism within the handle 1690 is configured to assist a user to rotate the handle 180 degrees, from the first side to the second side. The food is secured via a plurality of engagement members and allows for the frying assembly to cook the opposing side within a frying pan or over other sources of direct heat. The frying assembly 1000 comprises a first rack 1100 and a second rack 1200 operably connected at a first end 1120 to a bracket 1500 and spaced apart so as to form an interior space 1300 therebetween. In the illustrated embodiment, the first and second rack are disposed in a stacked configuration. The interior space 1300 is sized and adapted to receive food, such as meat, vegetables, and the like therein. In the shown embodiment, the stacked arrangement of the first and second racks 1100, 1200 are disposed on parallel horizontal planes. In the illustrated embodiment, the racks 1100, 1200 are circular and have a similar geometry such that when they are in the stacked arrangement, the racks are generally coextensive. In this way, the perimeter of the racks 1100, 1200 are entirely overlapped when viewed from an overhead position. In alternative embodiments, the racks 1100, 1200 are square or any other suitable shape.

In the shown embodiment, the racks 1100, 1200 comprise an interior face 1400 having a plurality of tines 1420 protruding towards the interior space 1300. Each tine 1420 is adapted to pierce or otherwise engage food placed within the interior space 1300. In one embodiment, each rack 1100, 1200 comprises a plurality of rows that support the tines 1420. In alternative embodiments, the rack 1100, 1200 comprises a plurality of rows and cross members (see FIG. 4). In another embodiment, the interior face does not include a plurality of tines and instead comprises a flat surface. In the shown embodiment, each rack 1100, 1200 includes apertures 1440 formed between the rows (and/or cross members) that allow fluid, such as oil, to pass therethrough and contact food positioned within the interior space. In the illustrated embodiment, the apertures 1440 are evenly spaced for uniform cooking of the food.

In the shown embodiment, the handle 1600 is affixed to the bracket 1500 and is adapted to cooperatively rotate both the first and second racks 1100, 1200 about a longitudinal axis 1800 of the handle 1600. In this way, the first and second racks 1100, 1200 are flipped so that opposing sides of food secured within the frying assembly 1000 engage the heat source below. The handle 1600 is generally an elongated member that extends outward from the racks 1100, 1200. In one embodiment, the handle 1600 includes a hinge 1620 that provides for selective collapsing of the handle 1600 to a storage configuration. The hinge 1620 is positioned between a distal end of the handle 1600 and the bracket 1500 such that the distal end of the handle 1600 is rotated towards the bracket 1500. In alternate embodiments, the hinge is positioned at the connection point between the handle 1600 and the bracket, such that the entire handle is parallel with the bracket 1500. In some embodiments, the handle is configured to rotate inward toward the bracket such that the handle maintains a parallel orientation with the racks in the stored configuration.

In some embodiments, a sleeve 1700 is disposed around a neck of the handle and adapted to independently rotate about the handle. In use, a user can grasp the sleeve with a first hand to support the weight of the assembly 1000 and rotate the handle with a second hand. In this way, a user can rotate the handle in one motion.

In the shown embodiment, the racks 1100, 1200 are operably connected at a first end 1120 to the bracket 1500. The bracket 1500 is adapted to provide linear movement of the first rack 1100 relative to the second rack 1200, such that the interior faces 1400 of the racks 1100, 1200 can be adjusted to sandwich food disposed between the racks 1100, 1200.

In some embodiments, the bracket 1500 allows for the user to selectively adjust the distance between the racks 1100, 1200 to accommodate food having different size and shapes. In the illustrated embodiment, the bracket 1500 is telescopic, wherein a pair of outer rods having a first diameter extend from an inner rod having a larger second diameter. The inner rod and outer rods are concentric and perpendicular to the handle. The outer rods slide in and out of the inner rod until the desired distance between the racks is achieved. In some embodiments, the bracket comprises a locking mechanism that prevents the bracket from moving. In the illustrated embodiment, the bracket is locked in position via a friction fit between the inner and outer rods.

In the shown embodiment, the handle 1600 comprises a first elongated member 1640 hingedly affixed to a second elongated member 1660, wherein the first and second elongated member 1640, 1660 are axially aligned therewith (and along the longitudinal axis 1800 of the handle) in a straight configuration. The second elongated member 1660 is adapted to rotate perpendicular to the first elongated member 1640 via the hinge 1620 and support the handle 1600 on a horizontal surface so as to keep the handle and the racks 1100, 1200 generally horizontally oriented.

In one embodiment, the second elongated member 1660 comprises an elongated base 1690 having a flat distal face for engaging the horizontal surface and to act as a stopper to prevent a hand from sliding past the handle 1600. In this way, during cooking using a frying pan, the base 1690 of the second elongated member 1660 rests flush on a tabletop adjacent the frying pan. The racks 1100, 1200 remains generally horizontal and evenly engaged with the frying pan for even heat distribution.

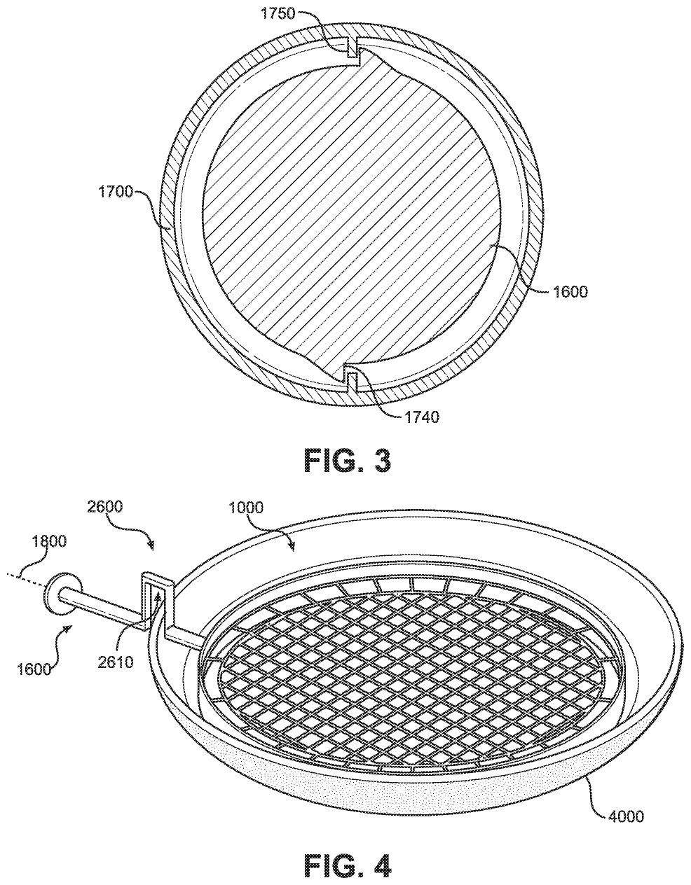

Referring now to FIG. 3, there is shown a cross sectional view of a handle of an embodiment of the frying assembly for flipping. In the illustrated embodiment, the frying assembly comprises a rotating mechanism configured to allow the handle and racks to automatically complete a 180-degree rotation about the longitudinal axis as soon as a user to partially rotates the handle in the same direction. This permits a user to effortlessly flip the racks from one side to the other side using a single motion of the wrist to rotate the handle.

In the illustrated embodiment, the rotating mechanism comprises a pawl formed between the handle 1600 and the sleeve 1700. The pawl comprises a pair of teeth 1740 extending from the exterior of the handle 1600 and on opposing sides. A lever or pair of retractable or movable tabs 1750 extend from an interior side of the sleeve 1700 and is adapted to engage each tooth upon rotation of the handle 1600. In the illustrated embodiment, the handle 1600 only needs to be rotated over each tab, wherein the handle will continue to rotate due to the force until the tab engages the second tooth. The teeth are opposite one another to allow a 180-degree rotation of the handle when each tab is released from a tooth, thereby allowing the racks to entirely flip from a first side to a second side. In the illustrated embodiment, each tab is flexible and configured to bend or fold towards the interior side of the sleeve in order to allow each tooth to rotate therethrough when rotational force is applied to the handle by the user.

Referring now to FIG. 4, there is shown a perspective view of a second embodiment of the frying assembly for flipping. In the shown embodiment, the handle 1600 comprises an elbow 2600 that forms a channel 2610 adapted to receive a sidewall of a frying pan 4000, wherein horizontal portions of the handle 1600 that meet the elbow 2600 on opposing sides thereof, are aligned on the same longitudinal axis 1800 of the handle 1600. In this way, the elbow 2600 allows the second rack 1200 to rest flat on the surface of the frying pan without obstruction from the handle 1600 and sidewall of the frying pan. In some embodiments, the elbow comprises a curved interior sidewall adapted to conform to a curved sidewall of the frying pan.

When flipped, the elbow 2600 may be placed inside or outside the sidewall of the frying pan such that the elbow 2600 abuts the sidewall. Additionally, the frying assembly 1000 is prevented from sliding within the frying pan since the elbow 2600 acts to prevent such motion. In some embodiments, a second elbow is disposed on a second bracket disposed on an opposing side of the frying assembly 1000 in order to receive the sidewall or edge of the frying pan when the racks 1100, 1200 are flipped over.

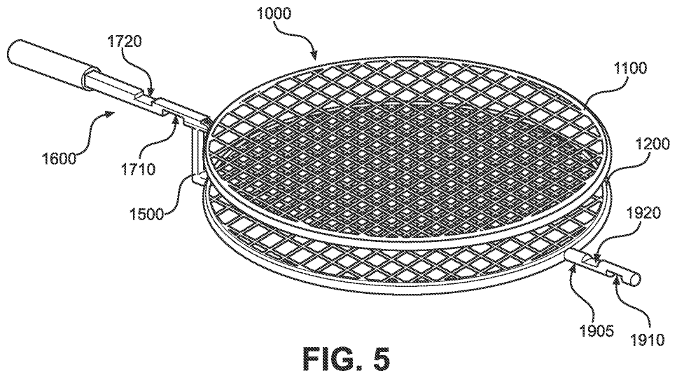

Referring now to FIG. 5, there is shown a perspective view of a third embodiment of the frying assembly for flipping. In the shown embodiment, the handle 1600 comprises a first notch 1710 sized to receive a sidewall of a frying pan, wherein the first notch 1710 extends lateral to the longitudinal axis 1800 of the handle 1600. In this way, the first notch 1710 receives the frying pan sidewall and prevents movement back and forth of the racks 1100, 1200 when positioned within the frying pan. The handle 1600 comprises a second notch 1720 on a side opposite the first notch 1710 and intermediate the first notch 1710 and the bracket 1500. The second notch 1720 provides the same function as the first notch 1710. However, this notch 1720 engages the sidewall of the frying pan when the frying assembly 1000 is flipped. Therefore, the frying assembly 1000 provides the same function regardless of position of the racks 1100, 1200 in the stacked arrangement.

In one embodiment, the frying assembly 1000 comprises an arm 1905 that extends outward therefrom and on opposing sides from the bracket 1500. The arm 1905 comprises a third notch 1910 sized to receive a sidewall of a frying pan, wherein the third notch 1910 extends lateral to the longitudinal axis 1800 of the handle 1600, and a fourth notch 1920 on a side opposite the third notch 1910. In the shown embodiment, the first and third notches 1710, 1910 are disposed on the same side and correspond with each other, such that they are adapted to both engage the sidewall of the frying pan simultaneously. The second and fourth notches 1720, 1920 are also disposed on the same side and correspond with each other, such that they are adapted to both engage the sidewall of the frying pan simultaneously.

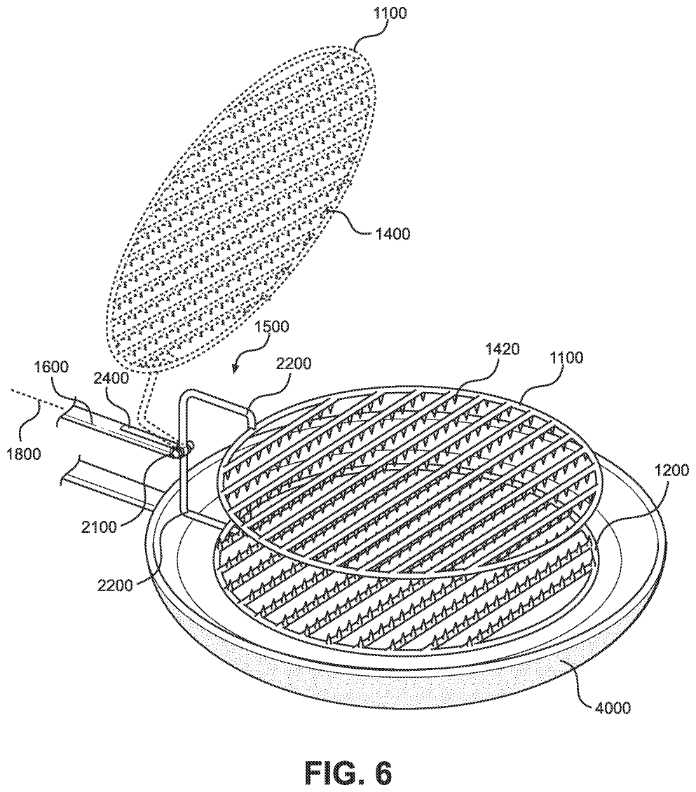

Referring now to FIG. 6, there is shown a perspective view of an embodiment of the frying assembly for flipping being used with a frying pan. In the shown embodiment, the first rack 1100 is hingedly affixed to the bracket 1500 to allow for access to the interior face 1400 of the second rack 1200. The first rack 1100 may selectively rotate away from the second rack 1200. The bracket 1500 is hingedly affixed to the handle via a hinge joint 2100, wherein the hinge joint 2100 is adapted to selectively rotate the first rack 1100 away from the second rack 1200 to provide access to the interior face 1400 of the second rack 1200. The bracket 1500 comprises a pair of bracket arms 2200 forming a C-shape, wherein the pair of brackets 2200 are affixed to the handle 1600 a proximal end of the bracket arms 2200. The term “C-shaped,” as used herein, includes any curved or bent shape, such as a “V” shape, that is capable of spacing the racks 1100, 1200 as described. The handle 1600 comprises a recess 2400 extending along the longitudinal axis of the handle adapted to receive a portion of one of the bracket arms. The recess 2400 is positioned adjacent the hinge joint 2100 and extends along the longitudinal axis 1800 of the handle 1600. The recess 2400 is adapted to receive a portion of one of the bracket arms 2200. In one embodiment, the recess 2400 receives the one of the bracket arms 2200 so as to orient the first rack 1100 in a vertical orientation relative to the handle 1600. In the illustrated embodiment, the handle is positioned centrally between the racks. This allows the handle to remain on a same horizontal plane when the first rack is on the top of the assembly or rotated to the bottom of the assembly.

In one use, the first rack 1100 of the frying assembly 1000 is moved to a maximum distance away from the second rack 1200 via the bracket 1500 (as shown in FIG. 1) to accommodate the food. Alternatively, the first rack 1100 may be rotated away from the second rack 1200 via the hinge joint 2100. In another alternative, both the bracket 1500 and the hinge joint 2100 may be utilized. The food is then placed onto the tines 1420 of the second rack 1200 on the interior face 1400 so as to secure the food thereto. The first rack 1100 is then lowered to engage the tines 1420 of the interior face 1400 of the first rack 1100. Once the food is secured between the racks 1100, 1200, a user may reposition the frying assembly 1000 by grabbing the handle 1600 to position the second rack 1200 within a pan. Should the frying assembly 1000 have the elbow 2600 or one or more notches 1710, 1720, 1910, 1920, the user may selectively position them with the sidewall of the frying pan.

A pan 4000 having heated oil is also provided. Once positioned within the pan 4000, the lower side of the food and the second rack are in direct contact with the oil. After some time, the user may selectively flip or rotate the frying assembly 1000 via the handle so as to orient the first rack to directly contact the oil. Once the food is cooked for a desired time and/or temperature, the first and second racks 1100, 1200 are moved apart to extract the cooked food.

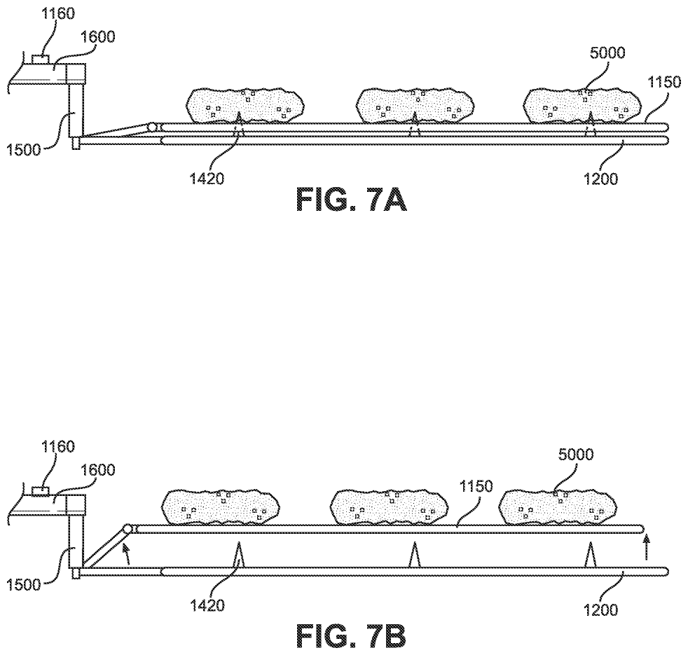

Referring now to FIGS. 7A and 7B, there is shown a close-up, side view of an embodiment of the frying assembly with actuatable panel for detaching food from tines in a retracted and deployed position, respectively. In the shown embodiment, an ejection panel 1150 is disposed on the interior face 1400 of the bottom rack 1200 and is configured to be positioned between the bottom rack and the food 5000 during use. The ejection panel 1150 is configured to remove or eject the food 5000 from the bottom rack 1200. In one embodiment, the ejection panel 1150 forms a grid pattern that corresponds with the arrangement of apertures and tines 1420, so as to allow the oil to contact the food 5000.

In some embodiments, the ejection panel 1150 is operably connected to a button or lever 1160 along the handle 1600, such that when actuated, the ejection panel 1150 is raised so as to force the food 5000 to be separated from the bottom rack 1200. In this way, the food 5000 does not stick to the racks 1200 during and after the cooking process. In one embodiment, the ejection panel 1150 includes nonstick material. In one embodiment, the frying assembly 1000 comprises an additional ejection panel 1150 on the top rack 1100 that acts to separate the food 5000 from both the racks 1100, 1200.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A frying assembly for flipping food, comprising:
a first rack and a second rack operably connected at a first end to a bracket and forming an interior space therebetween in a stacked configuration, wherein the interior space is adapted to receive food therein;
wherein the first rack and the second rack each comprise an interior face oriented towards one another;
wherein each interior face comprises a plurality of tines protruding towards the interior space, wherein each tine is adapted to engage the food placed within the interior space;
wherein each rack includes apertures that allow fluid to pass therethrough;
wherein the bracket is adapted to provide movement of the first rack relative to the second rack, such that the interior faces of the second rack and the first rack can be adjusted to sandwich food disposed therebetween;
a handle is affixed to the bracket and is adapted to cooperatively rotate both the first and second racks about a longitudinal axis of the handle.

2. The frying assembly of claim 1, wherein the first rack is hingedly affixed to the bracket so as to allow for access to an interior face of the second rack in an open configuration when the first rack is rotated away from the second rack.

3. The frying assembly of claim 1, wherein the stacked arrangement the first and second racks are disposed on parallel horizontal planes.

4. The frying assembly of claim 3, wherein the handle extends from the bracket and is positioned equidistant from the parallel horizontal planes of the first and second racks.

5. The frying assembly of claim 1, wherein the handle comprises a first elongated member hingedly affixed to a second elongated member, wherein the first and second elongated member are axially aligned therewith in a straight configuration.

6. The frying assembly of claim 5, wherein the second elongated member is adapted to rotate perpendicular to the first elongated member via the hinge and support the handle on a horizontal surface.

7. The frying assembly of claim 6, wherein the second elongated member comprises an annular base having a flat distal face for engaging the horizontal surface and to act as a stopper to prevent a hand from sliding past the handle.

8. The frying assembly of claim 1, wherein the handle comprises a first notch sized to receive a sidewall of a frying pan, wherein the first notch extends lateral to the longitudinal axis of the handle.

9. The frying assembly of claim 8, wherein the handle comprises a second notch on a side opposite the first notch and intermediate the first notch and the bracket.

10. The frying assembly of claim 8, comprises an arm extend outward therefrom and on opposing sides from the bracket, wherein the arm comprises a third notch sized to receive a sidewall of a frying pan, wherein the third notch extends lateral to the longitudinal axis of the handle, and a fourth notch on a side opposite the third notch.

11. The frying assembly of claim 1, wherein the handle comprises an elbow that forms a channel adapted to receive a sidewall of a frying pan, wherein horizontal portions of the handle that meet the elbow on opposing sides thereof, are aligned on the same longitudinal axis.

12. The frying assembly of claim 1, wherein the bracket comprises an adjustment member for vertically adjusting the first and second brackets, such that they may selectively increase or decrease the interior space.

13. The frying assembly of claim 1, wherein the bracket is hingedly affixed to the handle via a hinge joint, wherein the hinge joint is adapted to selectively rotate the first rack away from the second rack to provide access to the interior face of the second rack.

14. The frying assembly of claim 13, wherein the bracket comprises a pair of bracket arms forming a C-shape, wherein the pair of brackets are affixed to the handle a proximal end of the bracket arms.

15. The frying assembly of claim 14, wherein the handle comprises a recess extending along the longitudinal axis of the handle adapted to receive a portion of one of the bracket arms.

16. The frying assembly of claim 1, further comprising:
an ejection panel disposed on the interior face of one of the racks, wherein the ejection panel is movable between a retracted position and an ejection position;
wherein the retracted position the ejection panel is positioned against the first rack and the plurality of tines extend through the ejection panel;
wherein the ejection position, the ejection panel is moved away from the first rack so as to lift any food engaged with the plurality of tines to be ejected therefrom.

17. The frying assembly of claim 16, wherein the ejection panel is operably connected to an actuation button that transitions the ejection panel between the retracted position and the ejection position upon actuation thereof.

18. The frying assembly of claim 1, further comprising a rotating mechanism configured to allow the handle to automatically complete a 180-degree rotation thereby rotating the first rack and the second rack 180 degrees about the longitudinal axis.

19. The frying assembly of claim 18, further comprising a sleeve disposed around a neck of the handle and adapted to independently rotate therearound.

20. The frying assembly of claim 19, wherein the rotating mechanism comprises:
a pawl having a pair of teeth and a pair of tabs;
wherein the pair of teeth extend from opposing sides of the handle and beneath the sleeve;
wherein each of the pair of tabs extend from an interior side of the sleeve and adapted to engage each tooth upon rotation of the handle.
